(19) United States
(12) Patent Application Publication
(10) Pub. No.: US 2017/0139314 A1
(43) Pub. Date: May 18, 2017

(54) PROJECTOR AND IMAGE MODULE THEREFOR

(71) Applicant: National Applied Research Laboratories, Taipei (TW)

(72) Inventors: Jiun-Woei Huang, Taipei (TW); Shih-Feng Tseng, Taipei (TW); Wei-Cheng Lin, Taipei (TW); Lu-Hua Chen, Taipei (TW)

(73) Assignee: National Applied Research Laboratories, Taipei (TW)

(21) Appl. No.: 15/251,042

(22) Filed: Aug. 30, 2016

(30) Foreign Application Priority Data
Nov. 12, 2015 (TW) 104137409

(51) Int. Cl. G03B 21/28; G03B 21/14; G02B 27/00; G02B 17/08

(52) U.S. Cl. CPC G03B 21/28; G02B 17/0896; G03B 21/147; G02B 27/0025

(57) ABSTRACT

A projector having a first end and a second end opposite to the first end includes an image source, a mirror and a first lens set. The image source is disposed at the first end, and projects lights of an image along a first direction. The mirror is disposed at the second end along the first direction. The first lens set is disposed between the image source and the mirror, and forms for the lights a common aperture located between the first lens set and the mirror.

### CROSS REFERENCE

This application claims the benefit of Taiwan Patent Application No. 104137409, filed on Nov. 12, 2015, at the Taiwan Intellectual Property Office, the disclosures of which are incorporated herein in their entirety by reference.

### FIELD OF THE INVENTION

The present invention is related to an imaging module. In particular, the present invention is related to an imaging module used in a projector for projecting lights of an image from an image source.

### BACKGROUND OF THE INVENTION

During the last decade, the display format in the field of image display technology has evolved from high definition (HD), through 1920*1080, all the way to ultra-high definition (UHD) or 4K*2K. There are two main-stream products in the industry: one is a liquid crystal display (LCD) ranging from 10 to 100 inches, and the other is a projector. Although LCD products have been popular in the market, they have problems such as high investment cost for manufacturing and potential environmental pollution. Thus, imaging projection systems are an alternative for the sake of cost and environmental protection. Furthermore, image projection systems are low energy consuming and more flexible due to their compact size.

Some current projects directly use lenses to focus lights from the image source onto screens. To reduce the distance between the lens and the screen, wide-angle lenses are often used to form the images. Drawbacks for employing wide-angle lenses are mainly cost issues. There are quite a number of lenses in a wide-angle lens set, which causes difficulties in assembling the lens set. For high-quality imaging, non-spherical lenses are often used in wide-angle lens sets. The high cost of these wide-angle lenses causes this type of projector to have a very high price, which will not be popular in the market.

The invention in U.S. Pat. No. 7,239,452 adopts the technology of rear projection, and requires at least two reflecting mirrors with optic powers to enlarge the image to an extent that people can view it. The size of an entire projection system according to the invention is extremely large, which causes the rear projection systems to be less convenient compared to front projection systems.

The invention in U.S. Pat. No. 7,048,388 adopts the technology of front projection, which also requires at least two reflecting mirrors to form the image. These lenses in the projection system according to the invention are non-spherical lens, which are expensive. In addition, a common aperture for the lights in the invention is formed inside the lens set, which causes an insufficient enlargement rate. The same drawback also happens with the inventions in U.S. Pat. Nos. 7,529,032, 7,883,219 and 7,116,498. The projection system described in Taiwan patent No. 1403758 uses complicated reflecting structures and at least one non-spherical lens. The common aperture for the lights is also located inside the lens set.

In order to overcome the drawbacks in the prior art, the present invention introduces a novel design for cost-effective imaging modules for use in projectors. The particular design in the present invention not only solves the aforementioned problems, but is also easy to implement. Thus, the present invention has utility for the industry.

### SUMMARY OF THE INVENTION

A novel design for a projector is disclosed. In accordance with one aspect of the present invention, a projector having a first end and a second end opposite to the first end is disclosed. The projector includes an image source, a mirror and a first lens set. The image source is disposed at the first end, and projects lights of an image along a first direction. The mirror is disposed at the second end along the first direction. The first lens set is disposed between the image source and the mirror, and forms for the lights a common aperture located between the first lens set and the mirror.

In accordance with another aspect of the present invention, an imaging module for use in a projector to project lights of an image from an image source is disclosed. The imaging module comprises a first lens set and a concave mirror configured to face the exit side and reflect the lights from the exit side. The first lens set has an incident side and an exit side, and forms for the lights at the incident side a common aperture at the exit side.

In accordance with a further aspect of the present invention, an imaging module for use in a projector is disclosed. The imaging module comprises a lens set including an incident end to receive lights from an image source, an exit end and a common aperture for the lights. The exit end emits the lights. The common aperture is formed outside the exit end.

The objectives and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a schematic diagram showing a projector according to one embodiment of the present invention;

FIG. 2 is a schematic diagram showing the lens set in the embodiment as shown in FIG. 1;

FIG. 3 shows another embodiment of the lens set combination according to the present invention;

FIG. 4 shows yet another embodiment of the lens set combination according to the present invention.

### DETAILED DESCRIPTION OF THE PREFERRED EMBODIMENT

The present invention will now be described more specifically with reference to the following embodiments. It is to be noted that the following descriptions of the preferred embodiments of this invention are presented herein for the purposes of illustration and description only; they are not intended to be exhaustive or to be limited to the precise form disclosed.

The present invention makes use of a concave sinusoidal reflex mirror, spherical lenses, and forms for the lights a common aperture located between the first lens set and the mirror. The present invention reduces the cost of the projector, which is far more compact as well as more flexible than traditional projectors.

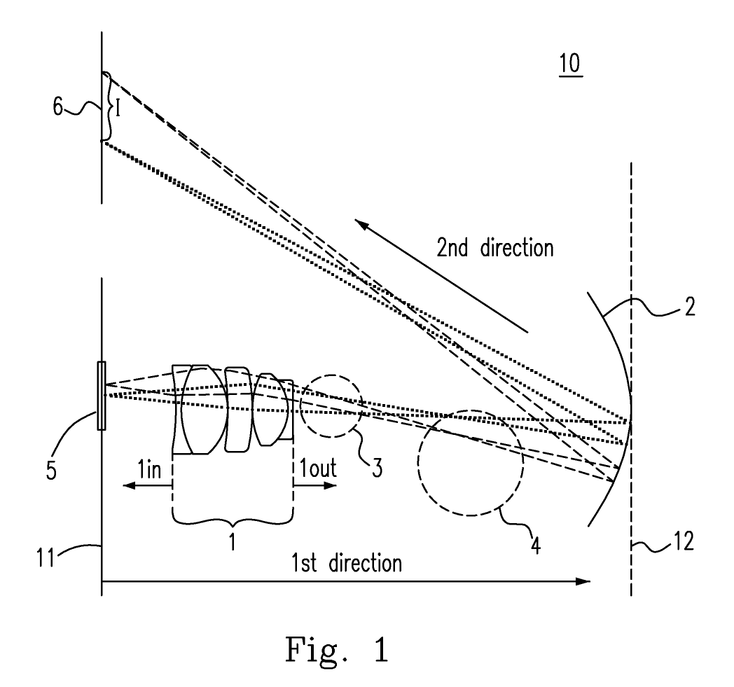

Please refer to FIG. 1, which is a schematic diagram showing a projector according to one embodiment of the present invention. FIG. 1, shows a projector 10 having a first end 11 and a second end 12 which is opposite to the first end. The projector 10 includes an image source 5 disposed at the first end 11 and projecting lights of an image (not shown) along a first direction, a mirror 2 and a first lens set 1 having an incident end 1ᵢₙ and an exit end 1ₒᵤₜ. The mirror is disposed at the second end 12 along the first direction. The first lens set 1 is disposed between the image source 5 and the mirror 2, and the first lens set 1 forms a common aperture 3 for the lights projected from the image source 5. In one preferred embodiment, the image source 5 is a telecentric planer light source, which projects lights that are nearly parallel to each other.

It can be seen that the common aperture 3 is located outside the exit end 1ₒᵤₜ of the first lens set 1 and between the first lens set 1 and the mirror 2. The mirror 2 is preferably a concave mirror that reflects the lights from the exit end 1ₒᵤₜ of the first lens set 1 and pass through the common aperture 3. Notably, the lights passing through the common aperture 3 form an intermediate image 4, which is preferably larger than the image in the image source 5, and further reflected by the mirror 2 along a second direction to form a projected image I on a screen 6.

According to one preferred embodiment, the mirror 2 is a concave non-spherical mirror, such as a Conic non-spherical mirror or a sinusoidal mirror. The non-spherical mirror can also be used to adjust any aberrations due to the use of spherical lenses for the first lens set 1. Therefore, the present invention both reduces cost and maintains the image quality. The size of the projected image I can be enlarged to a certain extent by changing the curvature or the radius of the curve of the mirror 2.

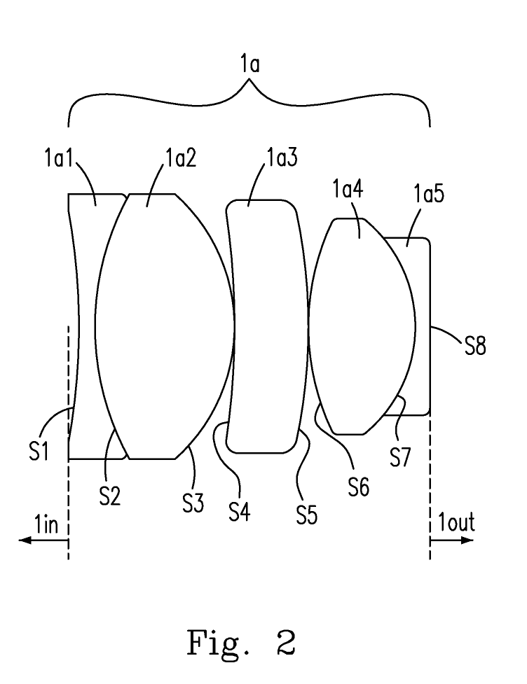

Refer to FIGS. 1 and 2, wherein the No. 1 relay lens set 1a in FIG. 2 is an embodiment of the first lens set 1 in the embodiment shown in FIG. 1. The No. 1 relay lens set 1a includes five lenses. Starting from the incident end 1ᵢₙ along the first direction to the exit end 1ₒᵤₜ, there are the first lens 1ₐ₁, the second lens 1ₐ₂, the third lens 1ₐ₃, the fourth lens 1ₐ₄ and the fifth lens 1ₐ₅. The first lens 1ₐ₁ and the second lens 1ₐ₂ form a compound lens, and the fourth lens 1ₐ₄ and the fifth lens 1ₐ₅ form another compound lens. Furthermore, the first lens 1ₐ₁ is a double concave lens with two surfaces, the first surface S1 and the second surface S2. The second lens 1ₐ₂ is a double convex lens having the second surface S2 facing the first lens 1ₐ₁ and a third surface S3 facing the third lens 1ₐ₃, which is a meniscus lens that focuses the lights. The third lens 1ₐ₃ has two surfaces the fourth surface S4 contacting the third surface S3 and the fifth surface S5 contacting the sixth surface S6 of the fourth lens 1ₐ₄. The fourth lens 1ₐ₄ is a double convex lens with the sixth surface S6 facing the third lens 1ₐ₃ and the seventh surface S7 facing and contacting the fifth lens 1ₐ₅. The fifth lens 1ₐ₅ is a plano-concave lens with the seventh surface S7 facing the fourth lens 1ₐ₄ and the eighth surface S8 which is flat and located at the exit end 1ₒᵤₜ. Based on this disclosure, the skilled person in the art can configure the lens set to focus the lights from the image source 5 to form a common aperture 3 (referring to FIG. 1) outside the exit end 1ₒᵤₜ of the lens set by determining appropriate curvatures of the surfaces and materials of the lenses.

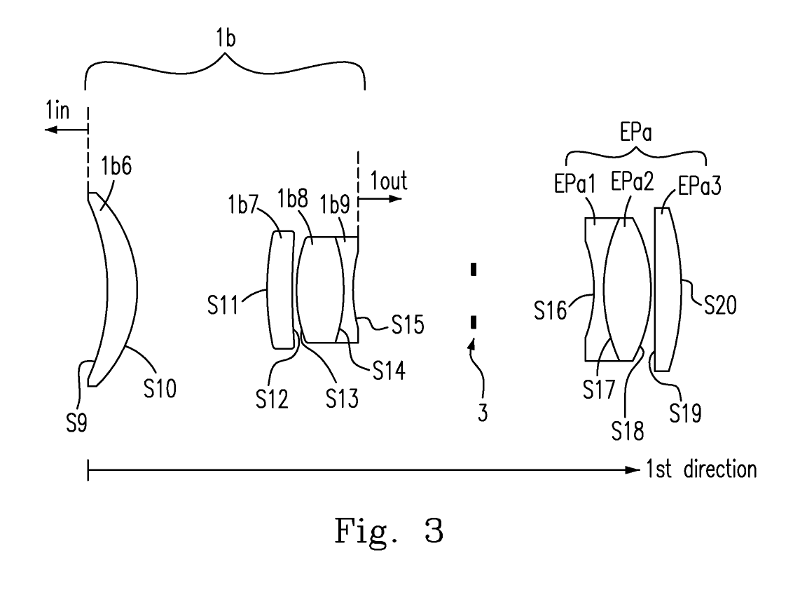

Refer to FIG. 3, which is a schematic diagram showing another embodiment of the lens set combination according to the present invention. FIG. 3 shows the second embodiment of the relay lens set. In FIG. 3, the second relay lens set 1b includes 4 lenses, which are the sixth lens 1_{b6}, the seventh lens 1_{b7}, the eighth lens 1_{b8}, and the ninth lens 1_{b9}, starting from the incident end 1ᵢₙ to the exit end 1ₒᵤₜ along the first direction.

The eighth lens 1_{b8}, and the ninth lens 1_{b9} form a compound lens. The sixth lens 1_{b6} is a meniscus lens having the ninth surface S9 which is a concave surface located at the incident end 1ᵢₙ and the tenth surface S10 which is a convex surface. The seventh lens 1_{b7} is a meniscus lens having the eleventh surface S11 which is a convex surface and the twelfth surface S12 which is a concave surface. The eighth lens 1_{b8} is a double convex lens with two surfaces, the thirteenth surface S13 and the fourteenth surface S14. The ninth lens 1_{b9} is a double concave lens having the fourteenth surface S14 facing and contacting the eighth lens 1_{b8} and the fifth surface S15 located at the exit end 1ₒᵤₜ. Based on this disclosure, the skilled person in the art can configure the lens set to focus the lights from the image source 5 to form a common aperture 3 outside the exit end 1ₒᵤₜ of the second relay lens set 1b by determining appropriate curvatures of the surfaces and materials of the lenses.

Again in FIG. 3, a first eyepiece EPa is disposed along the first direction to form an intermediate image 4 (referring to FIG. 1) at the rear side (right hand side) of the first eyepiece EPa. It can be seen that the common aperture 3 is at a location between the second relay lens set 1_{b} and the first eyepiece EPa. With the aid of the first eyepiece EPa, the size of the projected image I (referring to FIG. 1) can be enlarged by extending the distance between the mirror 2 and the screen 6. In addition, the eyepiece can also be used to further correct any aberrations. For this purpose, the first eyepiece EPa and the seventh, eighth and ninth lenses 1_{b7}, 1_{b8}, 1_{b9} in the second relay lens set 1b have a double Gauss lens design, i.e., the design with two groups of lenses (the first eyepiece EPa is one group, while the seventh, eighth and ninth lenses 1_{b7}, 1_{b8}, 1_{b9} are the other group) arranged in symmetry. Therefore, the first eyepiece lens EPa1 is a double concave lens having the sixteenth surface S16 and the seventeenth surface S17. The second eyepiece lens EPa2 is a double convex lens having the seventeenth surface S17 and the eighteenth surface S18. The first eyepiece lens EPa1 and the second eyepiece lens EPa2 form a compound lens. The third eyepiece lens EPa3 is a plano-convex lens, wherein the nineteenth surface S19 is flat and the twentieth surface S20 is a convex surface.

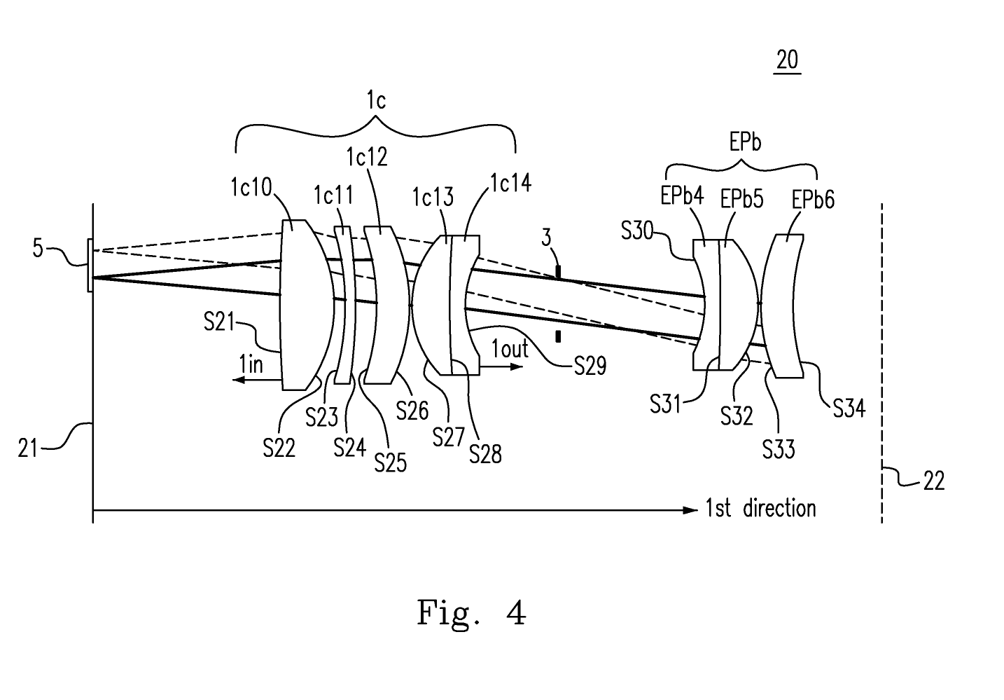

Please refer to FIG. 4, which illustrates another embodiment of the lens set combination according to the present invention. The illustration in FIG. 3 discloses the third embodiment of the relay lens set. In FIG. 4, the third relay lens set 1c includes 5 lenses, which are the tenth lens 1_{c10}, the eleventh lens 1_{c11}, the twelfth lens 1_{c12}, the thirteenth lens 1_{c13} and the fourteenth lens 1_{c14}, starting from the incident end 1ᵢₙ to the exit end 1ₒᵤₜ along the first direction. The thirteenth lens 1_{c13} and the fourteenth lens 1_{c14} form a compound lens.

The tenth lens 1_{c10} is a double convex lens having the twenty-first surface S21 located at the incident end 1ᵢₙ and the twenty-second surface S22. The eleventh lens 1_{c11} is a meniscus lens having the twenty-third surface S23 which is a concave surface and the twenty-fourth surface S24 which is a convex surface. The twelfth lens 1_{c12} is a meniscus lens having the twenty-fifth surface S25 which is a concave surface and the twenty-sixth surface S26 which is a convex surface. The thirteenth lens 1_{c13} is a meniscus lens having the twenty-seventh surface S27 which is a convex surface and the twenty-eighth surface S28 which is a concave surface for the thirteenth lens 1_{c13} but a convex surface for the fourteenth lens 1_{c14}, which is also a meniscus lens having another surface S29 being a concave surface located at the exit end. Based on the aforementioned disclosure, the skilled person in the art can configure the lens set to focus the lights from the image source 5 to form a common aperture 3 out of the exit end 1ₒᵤₜ of the third relay lens set 1c by determining appropriate curvatures of the surfaces and materials of the lenses.

Again in FIG. 4, a second eyepiece EPb is disposed along the first direction to form an intermediate image 4 (referring to FIG. 1) at the rear side (right hand side) of the second eyepiece EPb. It can be seen that the common aperture 3 is at a location between the third relay lens set 1c and the second eyepiece EPb. Likewise, with the aid of the second eyepiece EPb, the size of the projected image I (referring to FIG. 1) can be enlarged by extending the distance between the mirror 2 and the screen 6. In addition, the eyepiece can also be used to further correct any aberrations. For such a purpose, the second eyepiece EPb and the twelfth, thirteenth and fourteenth lenses 1_{c12}, 1_{c13}, 1_{c14} in the third relay lens set 1c can be a double Gauss lens design, i.e., a design with two groups of lenses (the second eyepiece EPb is one group, while the twelfth, thirteenth and fourteenth lenses 1_{c12}, 1_{c13}, 1_{c14} are the other group) arranged in symmetry. The second eyepiece EPb includes the fourth eyepiece lens EPb4, the fifth eyepiece lens EPb5 and the sixth eyepiece lens Epb6. Therefore, the fourth eyepiece lens EPb4 and the fifth eyepiece lens EPb5 are meniscus lenses, and form a compound lens. The fourth eyepiece lens EPb4 has the thirtieth surface S30 which is a concave surface and the thirty-first surface S31 is a convex surface for the fourth eyepiece lens EPb4 but a concave surface for the fifth eyepiece lens EPb5 with another surface, the thirty-second surface S32 being a convex surface. The sixth eyepiece lens EPb6 is a meniscus lens having the thirty-third surface S33 which is a convex surface and the thirty-fourth surface S34 which is a concave surface.

Based on the above, the projector and image module according to the present invention can project an image in a short distance with less distortion. Therefore the projector according to the present invention provides an enlarged projection image in a compact space. The image module is ideal for use in movie theaters, meeting rooms, living environments and head-up displays for automobile windshields or helmets.

### EMBODIMENTS

1. A projector having a first end and a second end opposite to the first end. The projector includes an image source, a mirror and a first lens set. The image source is disposed at the first end, and projects lights of an image along a first direction. The mirror is disposed at the second end along the first direction. The first lens set is disposed between the image source and the mirror, and forms for the lights a common aperture located between the first lens set and the mirror.
2. The projector of Embodiment 1, wherein an intermediate image is formed between the common aperture and the mirror.
3. The projector of Embodiment 2, wherein the intermediate image is larger than the image source.
4. The projector of Embodiment 1, wherein the mirror is a concave sinusoidal reflex mirror.
5. The projector of the previous embodiments, wherein the image source is a telecentric light-emitting element.
6. The projector of the previous embodiments, further comprising a second lens set disposed between the common aperture and the intermediated image.
7. The projector of the previous embodiments, wherein the second lens set includes a plurality of spherical lenses.
8. The projector of the previous embodiments, wherein the first lens set includes a plurality of spherical lenses.
9. An imaging module used in a projector for projecting lights of an image from an image source. The imaging module comprises a first lens set and a concave mirror. The first lens set has an incident side and an exit side, and forms for the lights at the incident side a common aperture at the exit side. The concave mirror is configured to face the exit side and reflect the lights from the exit side.
10. The imaging module of Embodiment 9, wherein the first lens set further forms an intermediate image between the common aperture and the concave mirror.
11. The imaging module of Embodiment 10, wherein the image source projects the lights along a first direction; and the intermediate image has a size larger than that of the image.
12. The imaging module of Embodiment 9, wherein the concave mirror is a sinusoidal surface mirror.
13. The imaging module of Embodiment 9, further comprising a second lens set disposed between the common aperture and the intermediate image.
14. The imaging module of Embodiment 13, wherein the second lens set includes a plurality of spherical lenses.
15. The imaging module of Embodiment 9, wherein the first lens set includes a plurality of spherical lenses.
16. An imaging module used in a projector, comprising a lens set including an incident end that receives lights from an image source, an exit end and a common aperture for the lights. The exit end emits the lights. The common aperture is formed outside the exit end.
17. The imaging module of Embodiment 16, further comprising a concave mirror reflecting the lights passing through the common aperture to form an image.
18. The imaging module of Embodiment 17, wherein the lens set further forms an intermediate image between the common aperture and the concave mirror.
19. The imaging module of Embodiment 16, wherein the image source is a telecentric light-emitting element.
20. The imaging module of Embodiment 16, wherein the lens set includes a plurality of spherical lenses.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A projector having a first end and a second end opposite to the first end, comprising:
an image source disposed at the first end, and projecting lights of an image along a first direction;
a mirror disposed at the second end along the first direction; and
a first lens set disposed between the image source and the mirror, and forming for the lights a common aperture located between the first lens set and the mirror.

2. The projector as claimed in claim 1, wherein an intermediate image is formed between the common aperture and the mirror.

3. The projector as claimed in claim 2, wherein the intermediate image has a size larger than that of the image.

4. The projector as claimed in claim 1, wherein the mirror is a concave sinusoidal reflex mirror.

5. The projector as claimed in claim 1, wherein the image source is a telecentric light-emitting element.

6. The projector as claimed in claim 1, further comprising a second lens set disposed between the common aperture and the intermediated image.

7. The projector as claimed in claim 7, wherein the second lens set includes a plurality of spherical lenses.

8. The projector as claimed in claim 8, wherein the first lens set includes a plurality of spherical lenses.

9. An imaging module used in a projector for projecting lights of an image from an image source, comprising:
a first lens set having an incident side and an exit side, and forming for the lights at the incident side a common aperture at the exit side; and
a concave mirror configured to face the exit side and reflect the lights from the exit side.

10. The imaging module as claimed in claim 9, wherein the first lens set further forms an intermediate image between the common aperture and the concave mirror.

11. The imaging module as claimed in claim 10, wherein:
the image source projects the lights along a first direction; and
the intermediate image has a size larger than that of the image.

12. The imaging module as claimed in claim 9, wherein the concave mirror is a sinusoidal surface mirror.

13. The imaging module as claimed in claim 9, further comprising a second lens set disposed between the common aperture and the intermediated image.

14. The imaging module as claimed in claim 13, wherein the second lens set includes a plurality of spherical lenses.

15. The imaging module as claimed in claim 9, wherein the first lens set includes a plurality of spherical lenses.

16. An imaging module used in a projector, comprising:
a lens set including:
an incident end receiving lights from an image source;
an exit end emitting the lights; and
a common aperture for the lights formed outside the exit end.

17. The imaging module as claimed in claim 16, further comprising a concave mirror reflecting the lights passing through the common aperture to form an image.

18. The imaging module as claimed in claim 17, wherein the lens set further forms an intermediate image between the common aperture and the concave mirror.

19. The imaging module as claimed in claim 16, wherein the image source is a telecentric light-emitting element.

20. The imaging module as claimed in claim 16, wherein the lens set includes a plurality of spherical lenses.
